(19) United States
(12) Patent Application Publication
(10) Pub. No.: US 2003/0117082 A1
(43) Pub. Date: Jun. 26, 2003

(54) Organic electroluminescent device compensated pixel driver circuit

(75) Inventor: Simon Tam, Cambridge (GB)

Correspondence Address: OLIFF & BERRIDGE, PLC, P.O. BOX 19928, ALEXANDRIA, VA, 22320, US

(73) Assignee: Seiko Epson Corporation, Tokyo, JP

(21) Appl. No.: 10/023,652

(22) Filed: Dec. 21, 2001

(51) Int. Cl. G09G 3/10

(52) U.S. Cl. 315/169.3

(57) ABSTRACT

A compensated pixel driver circuit for an organic electroluminescent device, wherein the circuit comprises a unity gain buffer which is preferably implemented as an operational amplifier. The circuit provides a unity gain sample and hold function, thereby compensating the current supply to the electroluminescent element by providing a self adjusting load.

The present invention relates to an organic electroluminescent device and particularly to a compensated pixel driver circuit thereof.

An organic electro-luminescent device (OELD) consists of a light emitting polymer (LEP) layer sandwiched between an anode layer and a cathode layer. Electrically, this device operates like a diode. Optically, it emits light when forward biased and the intensity of the emission increases with the forward bias current. It is possible to construct a display panel wide a matrix of OELDs fabricated on a transparent substrate and with one of the electrode layers being transparent. One can also integrate the driving circuit on the same panel by using low temperature polysilicon thin film transistor (TFT) technology.

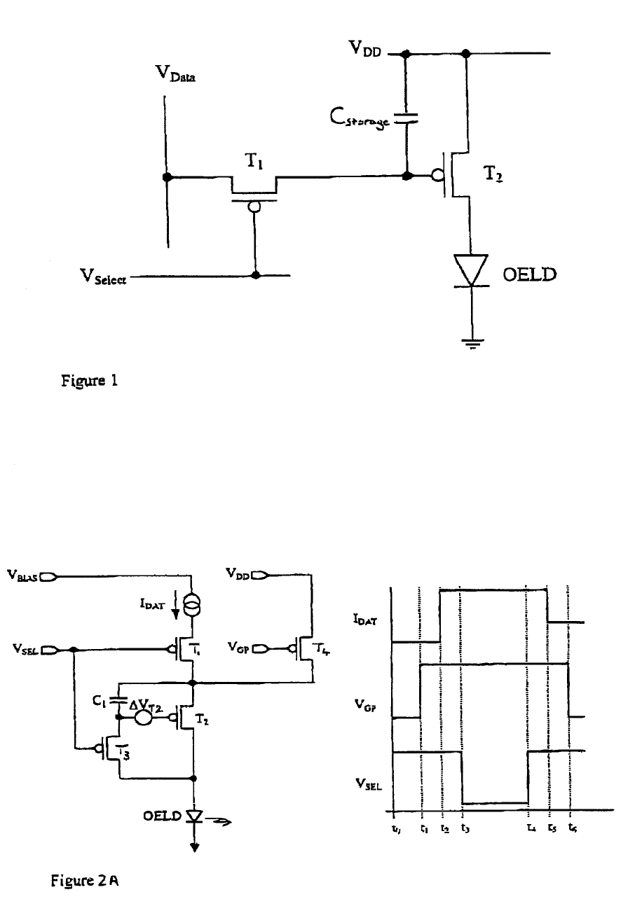

In a basic analog driving scheme for an active mat OELD display, a minimum of two transistors are required per pixel (FIG. 1): T₁ is for addressing the pixel and T₂ is for converting the data voltage signal into current which drives the OELD at a designated brightness. The data signal is stored by the storage capacitor C_{storage} when the pixel is not addressed. Although p-channel TFTs are shown in the figures, the same principle can also be applied for a circuit with n-channel TFTs.

There are problems associated with TFT analog circuits and OELDs do not act like perfect diodes. The LEP material does, however, have relatively uniform characteristics. Due to the nature of the TFT fabrication technique, spatial variation of the TFT characteristics exists over the entire panel. One of the most important considerations in a TFT analog circuit is the variation of threshold voltage, ΔV_{T}, from device to device. The effect of such variation in an OELD display, exacerbated by the non perfect diode behaviour, is the non-uniform pixel brightness over the display panel, which seriously affects the image quality. Therefore, a built-in compensation circuit is required.

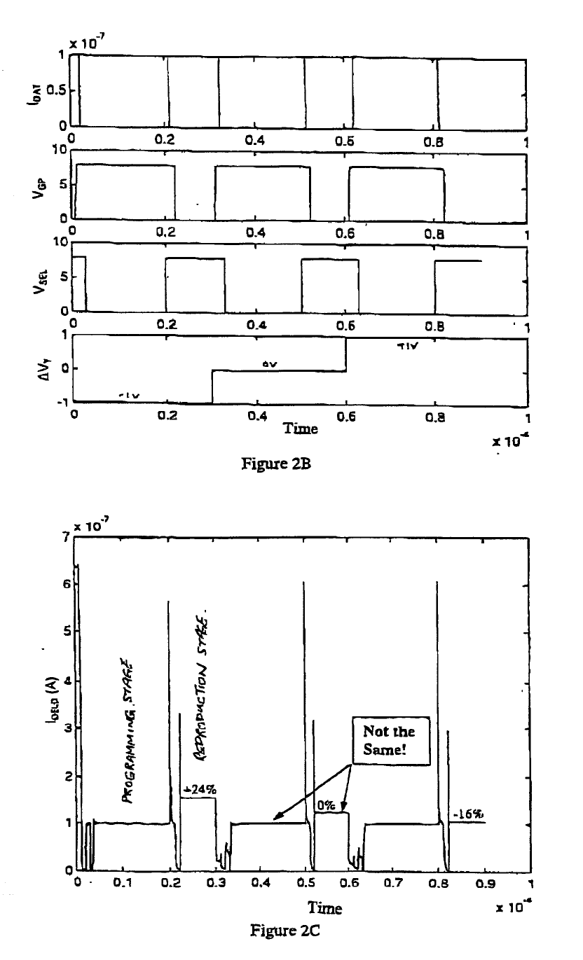

A simple threshold voltage variation compensation, current driven, circuit has been proposed. The current driven circuit, also known as the current programmed threshold voltage compensation circuit is illustrated in FIG. 2A. In this circuit, T₁ is for addressing the pixel. T₂ operates as an analog current control to provide the driving current. T₃ connects between the drain and gate of T₂ and toggles T₂ to be either a diode or in saturation. T₄ acts a switch. Either T₁ or T₄ can be ON at any one time. Initially, T₁ and T₃ are OFF, and T₄ is ON. When T₄ is OFF, T₁ and T₃ are ON, and a current of known value is allowed to flow into the OLED, through T₂. This is the programming stage because the threshold voltage of T₂ is measured with T₂ operating as a diode (with T₃ turned ON) while the programming current is allowed to flow through T₁, through T₂ and into the OELD. T₃ shorts the drain and gate of T₂ and turns T₂ in to a diode. The detected threshold voltage of T₂ is stored by the capacitor C₁ connected between the gate and source terminals of T₂ when T₃ and T₁ are switched OFF. Then T₄ is turned ON, the current is now provided by V_{DD}. If the slope of the output characteristics were flat, the reproduced current would be the same as the programmed current for any threshold voltage of T₂ detected. By turning ON T₄, the drain-source voltage of T₂ is pulled up, so a flat output characteristic will keep the reproduced current the same as the programmed current. Note that ΔV_{T2} shown in FIG. 2A is imaginary, not real.

A constant currant is provided, in theory, during the active programming stage, which is t₃ to t₄ in the timing diagram shown in FIG. 2A. The reproduction stage starts at t₆ and ends at t₁ of the next cycle.

In practice, there is always a slope in the output characteristics, so the reproduced current is not the same as the programmed current. This issue limits the device channel length of the polysilicon TFTs because of the increase of the short channel effect in polysilicon TFTs when the device channel length gets smaller. Simulations show that the variation between the reproduced current and programmed current is unacceptable for L=4 μm and below. This limitation on the design of transistor T₂ is a very serious practical problem, especially when small data currents are used. It is therefore important to find a technique that will provide good compensation in short channel devices.

The driving waveforms used are shown in timing chart fashion in FIG. 2B. The threshold voltage V_{T} shown at the bottom of FIG. 2D is that for transistor T₂. As can be seen from FIG. 2B, this threshold voltage has a range of −1V to +1V. Such a range is much larger than the variation ΔV_{T} across a practical OELD mate.

Typical variation between the reproduced current and programmed current supplied to the OELD is illustrated in FIG. 2C. FIG. 2C illustrates three cycles of OELD current supply: one from 0 to 30 μs, one from 30 μs to 60 μs, and one from 60 μs to 90 μs. The first half of each of these cycles is the programming stage and the second half of the cycle is the reproduction stage. It is to be noted that the current output levels in the reproduction stage compared with those in the corresponding program stage are remarkably different firm each other.

According to a first aspect of the present invention there is provided a compensated pixel driver circuit for an organic electroluminescent device, wherein the circuit comprises a unity gain buffer. Preferably the unity gain buffer is implemented as an operational amplifier.

According to a second aspect of the present invention there is provided a method of compensating the current supply to an organic electroluminescent pixel comprising. The step of using a unity gain buffer to provide a self adjusting load.

According to a third aspect of the present invention there is provided an organic electroluminescent display device comprising one or more compensated pixel driver civets according to the first aspect of the invention.

Embodiments of the present invention will now be described by way of example only and with reference to the accompanying drawings, in which:

FIG. 1 shows a conventional OELD pixel driver circuit using two transistors,

FIG. 2 shows a current programmed OELD driver with threshold voltage compensation,

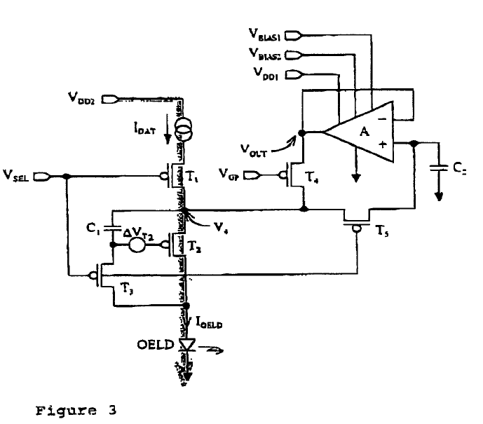

FIG. 3 shows a compensated pixel driver circuit according to an embodiment of the present invention,

FIG. 4 is a table of requirements for one specific example of an operational amplifier which can be used in the circuit of FIG. 3,

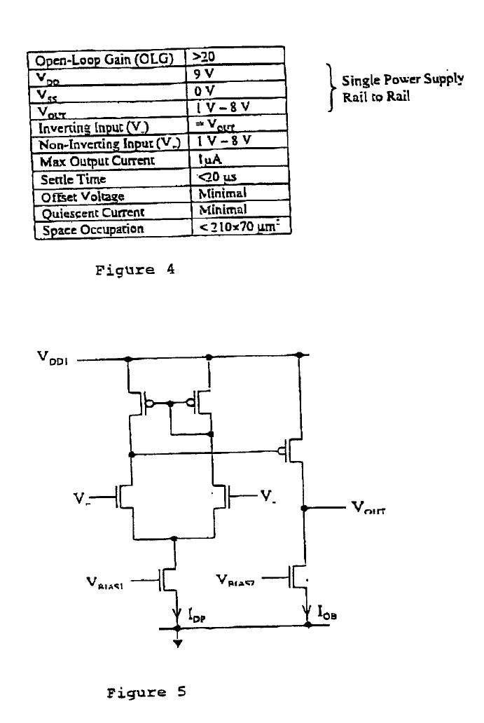

FIG. 5 is an example of a circuit for implementing the operational amplifier shown in FIG. 3,

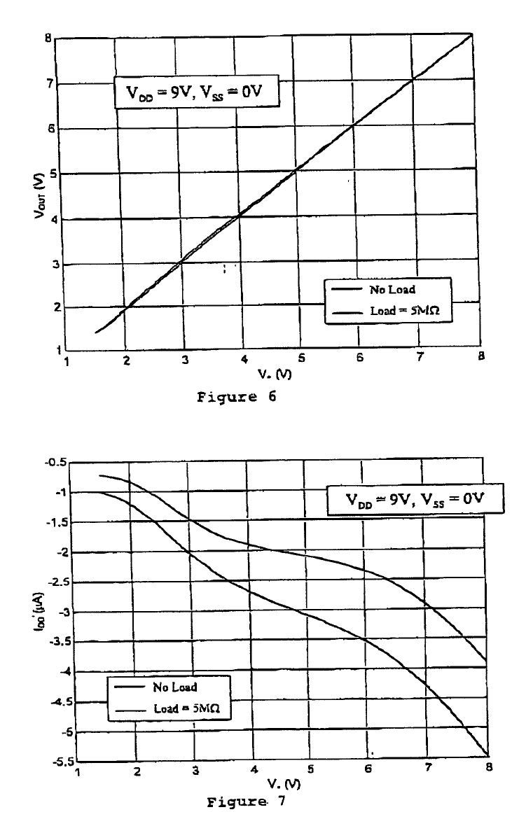

FIG. 6 is a graph illustrating the unity-gain buffer characteristics of the compensating circuit of FIG. 3,

FIG. 7 is a graph illustrating the total required supply current,

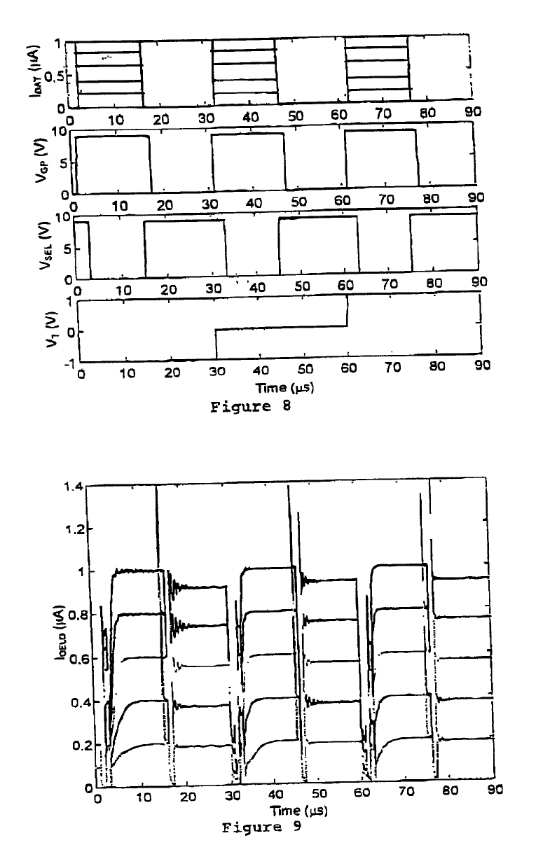

FIG. 8 is a driving waveform timing diagram, and

FIG. 9 illustrates the current output to the OELD using the circuit of FIG. 3.

A compensated pixel driver circuit according to an embodiment of the present invention is shown in FIG. 3. Compared with the circuit of FIG. 2, there is added an operational amplifier OpAmp A, a capacitor C₂ and a transistor T₅. As shown in FIG. 3, Vₒᵤₜ of the OpAmp is connected to the inverting input V₋ thereof. The OpAmp thus has unity gain. Capacitor C₂ ensures a sample ad hold function and transistor T₅ acts as a control switch to store the voltage on C₂. In effect the circuit provides a self-adjusted load or voltage source (V_{DD}) and by thus holding the operative voltage constant the effect of the slope in the output characteristics can be avoided. In it's generic form, the OpAmp A is a unity gain buffer having it's input connected to the source-drain path of transistor T₅ and it's output connected to the source-drain path of transistor T₄, the input being connected to ground via capacitor C₂.

As shown in FIG. 3, a TFT operational amplifier configured as a sample and hold circuit is used to provide a variable V_{DD} so that the drain-source voltage of T₂ in the reproduction stage is the same as that during the programming stage. During the programming stage, the voltage at the source of T₂ is passed to the storage capacitor C₂ at the input of the unity-gain OpAmp. The output of the OpAmp faithfully reproduces the voltage and also provides the current to the OELD through T₂. The driving waveform is the same as that for the circuit of FIG. 2.

The program current path is from V_{DD2} through node V₄, T₁, T₂ and the OELD. The reproduction current path is from V_{DD1}, through the OpAmp, Vₒᵤₜ, T₄, node V₄, T₂ and the OELD.

In the circuit of FIG. 3, the voltage at point V₄ is substantially the same in the reproduction cycle to the voltage at that point in the programming cycle. Additionally, a very high Open-Loop Gain (OLG) is not required in contrast to usual TFT circuits. An advantage of the embodiment of the present invention shown in FIG. 3 is that the current flow to the OELD during the reproduction cycle is less sensitive to the variation in the output Vₒᵤₜ of the OpAmp than ΔV_{T2} detection of the same percentage error. Furthermore, the OpAmp design constraints are not stringent.

FIG. 5 is a circuit diagram of one arrangement for implementing the OpAmp shown in FIG. 3. The specific requirements for this circuit are shown in the table of FIG. 4. Of particular note is the minimal off-set voltage. Typically is might be a few millivolts, in contrast to the variation of several volts which may typically arise in the conventional arrangement due to the slope of the output characteristics. The circuit of FIG. 5 essentially consists of a differential pair circuit and a driver. The differential pair circuit comprises the toy two transistors connected to the V_{DD1} rail, the respective transistors having their gates providing the two input terminals of the OpAmp, and the transistor whose gate receives V_{bias1}. The output driver comprises a transistor receiving V_{bias2} at its gate and a transistor connected between the V_{DD1} rail and Vₒᵤₜ.

All of the transistors of the circuit of FIG. 5 are TFTs having a channel led of 10 μm (in contrast to T₂). This channel length avoids the devices being stressed by the high value of V_{DD}. The transistor connected between the V_{DD1} rail and Vₒᵤₜ has a channel width of 100 μm in order to ensure sufficient current output. The area required to implement the circuit of FIG. 5 can be reduced by varying the W/L absolute size ratio of the transistors, subject to a corresponding reduction in the maximum drive current. The space occupation value of 270 μm×70 μm given in the table of FIG. 4 can, for example, be reduced to approximately 130 μ×10 μm, subject to a reduction in the maximum drive current from 5 μA to 15 μA. However, in practice a maximum drive current of 1 μA might suffice (as indicated in FIG. 4).

In the specific example given, the current I_{DP} flowing through the differential pair circuit has a maximum value of 1 μA and the current I_{OB} flowing through the driver circuit has a maximum value of 5 μA. The additional current required by the presence of the OpAmp is thus minimal.

FIG. 6 is a graph illustrating the unity-gain buffer characteristics of the compensating circuit of FIG. 3. As shown, the plot of Vₒᵤₜ against V₊ is the same for both the load and the no-load conditions. The load condition is 5 MΩ, which corresponds to a current of 1 μA through the OELD.

The total current supply required by the OpAmp of FIG. 3, in one specific example, is shown in FIG. 7. The total current supply required is that required by the differential pair circuit (FIG. 5), tat required by the OpAmp driver circuit (FIG. 5) and that required to drive the OELD. Again load (5 MΩ) and no-load conditions are shown.

The driving waveforms used with one implementation of the circuit of FIG. 3 am shown in timing chart fashion in FIG. 8. Of course, the threshold voltage V_{T} shown at the bottom of FIG. 8 is that for transistor T₂. As can be seen from FIG. 8, this threshold voltage has a range of −1V to +1V. Such a range is much larger than the variation ΔV_{T} across a practical OELD matrix. Threshold variation ΔV_{T} in other transistors (T₁, T₃, T₄, T₅) have little effect as they are used as switches and operate under voltage ranges greater than ΔV_{T}.

The output current supplied to the OELD using the circuit of FIG. 3 is illustrated in FIG. 9. FIG. 9 illustrates three cycles of OELD current supply one from 0 to 30 μs, one from 30 μs to 60 μs, and one from 60 μs to 90 μs. The first half of each of these cycles is, of course, the program stage and the second half of the cycle is the reproduction stage. In each cycle, five different program currents are illustrated (ie vertically—at 0.2, 0.4, 0.6, 0.8 and 1.0). It is to be noted that the current output levels in the reproduction stage compared with those in the commanding program stage are remarkably close. The comparison is slightly less good for larger program currents, but is still relatively small. Moreover, the difference can be predicted (as shown in FIG. 9) and can therefore be included in a gamma compensation (eg use 1.1 μA instead of 1 μA in the programming stage).

It will be apparent to persons skilled in the art that variations and modifications can be made to the arrangements described with respect to FIGS. 3 to 9 without departing from the scope of the invention.

1. A compensated pixel driver circuit for an organic electroluminescent device, wherein the circuit comprises a unity gain buffer.

2. A compensated pixel driver circuit as claimed in claim 1, wherein the unity gain buffer is implemented as an operational amplifier.

3. A compensated pixel driver circuit as claimed in claim 1 or claim 2, wherein the buffer is connected to have unity gain.

4. A compensated pixel driver circuit as claimed in claim 2, wherein the circuit comprises a transistor connected so as to act as a current switch for storing voltage an the said capacitor.

5. A compensated pixel driver circuit as claimed in any preceding claim, wherein the buffer comprises a differential pair circuit and a driver circuit.

6. A compensated pixel driver circuit as claimed in claim 5, wherein the differential pair circuit comprises two transistors whose gates respectively provide an inverting input and a non-inverting input of the buffer and a father transistor whose gate provides a bias voltage input of the buffer.

7. A compensated pixel drive circuit as claimed in claim 5 or claim 6, wherein the driver circuit comprises two transistors connected in series with the output of the buffer being taken from the said connection between these transistors.

8. A compensated pixel driver circuit as claimed in any preceding claim, wherein the circuit is implemented with polysilicon thin film transistors.

9. A method of compensating the current supply to a organic electroluminescent pixel comprising the step of using an buffer to provide a self adjusting load.

10. An organic electroluminescent display device comprising one or more compensated pixel driver circuits as claimed in any of claims 1 to 8.
